(19) United States
(12) Patent Application Publication
(10) Pub. No.: US 2004/0126556 A1
(43) Pub. Date: Jul. 1, 2004

(54) Grip element

(76) Inventors: Michael T. Nowak, Cheshire, CT (US); Ronald S. Rukan, Wallingford, CT (US)

Correspondence Address: JONES DAY, 51 Louisiana Aveue, N.W, WASHINGTON, DC, 20001-2113, US

(21) Appl. No.: 10/329,704

(22) Filed: Dec. 27, 2002

(51) Int. Cl. B32B 3/26; B32B 3/00

(52) U.S. Cl. 428/304.4; 428/313.3; 428/313.5

(57) ABSTRACT

The present invention relates to a grip element configured for assembly over at least a portion of an article to cushion at least the fingers of a user. The grip element includes a foam comprising (1) a copolymer having repeat units derived from a nitrile-containing monomer and a diene monomer and (2) a plasticizer to plasticize said foam, said foam being essentially free of (1) vinyl chloride and (2) phthalate plasticizers. Said foam is compressible and deformable in response to application of gripping pressure thereto.

### FIELD OF THE INVENTION

The present invention relates to a grip element for a hand-held and/or finger-manipulable article. More particularly, the present invention relates to a grip element which is easily assembled onto an article, such as a hand-held or finger-manipulable article. More particularly, the present invention relates to a grip element which is made from a soft, readily deformable material but which also is easy to manufacture and easy to assemble on a hand-held article.

### BACKGROUND OF THE INVENTION

With the increasing attention to ergonomic designs, handle portions of hand-held or finger-manipulable articles are increasingly designed to enhance gripping thereof. For instance, handles are often contoured and/or textured to facilitate grasping. Such formation of handles has been known for many years. It has become increasingly desirable to enhance gripping even further by providing a grip element formed from a material different from the material of the handle portion. The different material may provide unique characteristics not achievable by the material from which the main body of the handle must be formed. For instance, hand-held and finger-manipulable articles may be formed from such materials as plastics or metals or woods which are hard and/or slippery. The provision of a grip element formed from a material different from that of the underlying article, such as rubber or foam, has become increasingly popular. Such grip elements may provide such benefits as reduced slippage (increased friction), an insulative effect (i.e., an element that is not cold to the touch), and/or cushioning.

The manufacture of rubber and foams, however, may involve the use of possibly or potentially environmentally hazardous compounds. For example, rubber and foams may include copolymers formed of vinyl chloride monomers and/or styrene monomers. Other examples include phthalate compounds, which have been used to plasticize such rubber compounds. Disposal costs associated with such compounds raise overall manufacturing costs.

There is a need for a grip element that requires decreased amounts of potentially hazardous materials to produce the grip.

### SUMMARY OF THE INVENTION

One aspect of the present invention relates to a grip element configured for assembly over at least a portion of a finger-manipulable article to cushion at least the fingers of a user. In one embodiment the grip element comprises a foam comprising a copolymer having repeat units derived from a nitrile monomer and a diene monomer and a plasticizer to plasticize the foam, wherein the foam is essentially free of phthalate plasticizers and is resilient and deformable in response to application of gripping pressure thereto.

In another embodiment, the grip element comprises a foam comprising a copolymer having at least nitrile repeat units and diene repeat units and a plasticizer to plasticize the foam, wherein the foam is essentially free of phthalate plasticizers and is resilient and deformable in response to application of gripping pressure thereto.

In another embodiment, the grip element comprises a foam formed by polymerization of a mixture comprising (1) a nitrile monomer, (2) a diene monomer, and (3) a plasticizer, wherein the mixture is essentially free of aromatic esters.

Another aspect of the present invention relates to a finger-manipulable article having a grip element configured to cushion at least the fingers of a user. The grip element may be any grip element in accordance with the present invention.

Another aspect of the present invention relates to a method for manufacturing a writing instrument. In one embodiment the method comprises providing a grip element in accordance with the present invention. For example, the grip element may comprise a foam comprising a copolymer having at least repeat units derived from a nitrile-containing monomer and a diene monomer, and a plasticizer to plasticize the foam. The foam may be essentially free of phthalate plasticizers and be resilient and deformable in response to application of gripping pressure thereto. A writing instrument is provided and the grip element is operably associated with the writing instrument. It should be understood that providing a grip element may comprise providing an at least essentially fully formed grip element to be operably associated with a writing instrument.

Yet another aspect of the invention relates to a foam, such as a foam that may be used in cushioning applications, for example, to cushion at least the fingers of a user of a writing instrument. In one embodiment, the foam comprises a copolymer having repeat units derived from a nitrile monomer and a diene monomer and a plasticizer to plasticize the foam. The foam may be essentially free of phthalate plasticizers and resilient.

### BRIEF DESCRIPTION OF THE DRAWINGS

The detailed description will be better understood in conjunction with the accompanying drawings, wherein:

FIG. 1 shows a side elevational view of an exemplary grip element of the invention; and

FIG. 2 shows a perspective view of the grip element of FIG. 1 operatively associated with a writing instrument.

### DETAILED DESCRIPTION OF THE INVENTION

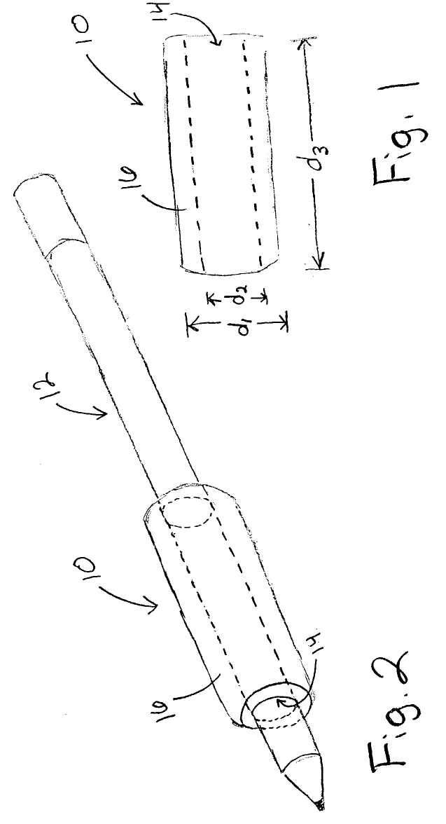

Referring to FIGS. 1 and 2, an exemplary grip element 10 formed in accordance with the principles of the present invention is configured to be positioned on a gripping portion of an article, such as a writing instrument 12. Preferably, grip element 10 is formed with a mounting structure, such as a receiving channel 14 in which a portion of an article is inserted to mount grip element 10 thereon. It is noted that reference herein is made to a “receiving channel” for the sake of convenience, and not with any intent to limit the mounting structure to only a “receiving channel.” For instance, grip element 10 may be inserted over a portion of a hand-held article and advanced until positioned over the gripping portion of the article. If more than one gripping portion is provided on a given hand-held article, then more than one grip element 10 may be provided, a grip element 10 being provided over each gripping portion. Grip element 10 may be positioned over a portion of an article which is specifically configured to receive grip element 10 or may be formed for insertion over an article not specially designed for receiving any type of element thereover. Thus, grip element 10 may be positioned in a recess to impart a substantially constant diameter to the article or may form a widened diameter portion of the article when mounted on the article.

Exemplary finger-manipulable articles on which grip element 10 may be provided include, without limitation, writing instruments, razors, toothbrushes, and finger-manipulable utensils such as for eating or cooking. If desired, grip element 10 may be formed to be specifically dimensioned and configured for a readily manipulable article and/or for an article which is gripped and/or manipulated by a user's fingers to alleviate pressure caused by excessive grip force being applied by the user without the article transmitting external forces to the user. Thus, grip element 10 may be configured to provide comfort and pressure alleviation to the user.

Alternatively, grip element 10 may be applied to hand-held articles (e.g. articles manipulated not just with the fingers but also with the palm of the hand, such as a pool cue) or to handles of objects like impact tools (e.g., hammers), sports equipment (e.g., golf clubs, bicycles, or tennis rackets), motor-driven devices (e.g., power drills or motorcycles), etc., which are not intended for gripping and manipulation by only the fingers and/or which transmit impact or vibration or other potentially uncomfortable sensation to the user (i.e., such discomfort is not caused by the user's excessive gripping pressure of the article but rather is imparted to the user by the article being gripped). Thus, grip element 10 may be configured to provide shock absorption during use of the article.

As applied for comfort instead of shock absorption, grip element 10 need not be as thick as would be necessary to insulate the user from external forces. If applied to a finger-manipulable article, grip element 10 may have a total outer radial dimension d₁ of preferably less than about 2.5 cm, such as less than about 2 cm, for ready gripping by fingers alone. An internal radial dimension d₂ of receiving channel 14 may be less than about 1.5 cm, such as less than about 1.0 cm. However, it will be appreciated that the dimensions and configuration of grip elements of the present invention may be adapted to provide cushioning to any type of article grasped by a user.

Receiving channel 14 is configured to receive a portion of an article preferably securely therein. Preferably, receiving channel 14 is dimensioned and configured to correspond to the outer dimension of the portion of the article on which grip element 10 is to be mounted so that that portion is securely maintained therein. However, the mounting structure may be configured in any other manner to secure the article therein. For example, an interior of receiving channel 14 may include flexible ribs, which resiliently conform to the exterior of the portion of the article to be received within receiving channel 14. If desired, the article and receiving channel 14 may be matingly contoured, such as by the provision of grooves on one and ribs on the other which mate or engage with each other. Other mating contours are within the scope of the present invention as well.

It will be appreciated that grip element 10 need only extend over the gripping portion of the article on which grip element 10 is provided. Accordingly, the overall longitudinal extent d₃ of grip element 10 may be relatively short, particularly when compared to the length of the article. For example, the longitudinal extent d₃ may be less than about 7 cm, such as less than about 5 cm.

Grip element 10 is configured to facilitate gripping of the article on which grip element 10 is positioned. Because hand-held articles, such as writing instruments, may be gripped unduly tightly, and may be so hard that such tight gripping results in discomfort, grip element 10 is configured to increase comfort to the user during gripping of grip element 10 even when the user very tightly grips grip element 10 on an article. Alternatively, or in addition, grip element 10 may be configured to provide shock absorption, as described above.

Grip element 10 preferably comprises at least one foam portion that is compressible and deformable in response to application of gripping pressure thereto so as to provide cushioning to at least the fingers of a user. The foam is preferably resilient and/or non-brittle so that, upon a reduction in compression applied by a user, the foam tends to return to the uncompressed shape of the foam. In one embodiment, grip element 10 consists essentially of foam. However, grip element 10 may include portions that are not necessarily formed of foam. For example, an outer surface 16 of grip element 10 may include a coating, such as a water resistant coating. The outer surface 16 may be substantially smooth or may be textured, such as with grooves or roughened features that enhance a user's grip or the tactile characteristics of grip element 10. The grip element 10 may also include a support portion adapted to provide support to the foam portion and/or to facilitate securing the grip to an article. For example, a surface of grip element 10 intended to mate with an article may include a coating to facilitate mounting, e.g., such as by sliding the grip element 10 onto the article.

As used herein, the term “foam” refers to a cellular material comprising at least a first solid phase and at least a first fluid phase. The at least one solid phase preferably comprises a copolymer or copolymer blend. A plasticized acrylonitrile-butadiene-rubber is a preferred solid phase. The at least one fluid phase is dispersed within the solid phase in the form of voids or pockets referred to as cells. Upon formation of the foam, cells of preferred foams may contain a gas, such as nitrogen, carbon dioxide, or water vapor. It is understood, however, that at least some of the gas present upon formation of the foam may be replaced by an ambient gas, such as air, if the gas present upon formation of the foam migrates from the cells. Voids may also be formed by incorporation of preformed solid expanded cells or solid or fluid materials that react or decompose thereby providing cells. Cells of foams of the invention may be interconnected to form an open-cell foam or a substantial number of the cells may be isolated from other cells thereby forming a closed cell foam.

Preferred foams of the present invention comprise at least one copolymer. An exemplary copolymer includes nitrile and diene repeat units such as those that may be formed upon the reaction of (1) at least one nitrile monomer, and (2) at least one diene monomer. A nitrile monomer is a compound that contains at least one nitrile group. Exemplary nitrile monomers include acrylonitrile and methacrylonitrile. A diene monomer is a compound that includes two carbon-carbon double bonds. Exemplary diene monomers include butadiene, isoprene and the like. A preferred diene monomer is 1,3-butadiene. A preferred copolymer is an acrylonitrile-butadiene-rubber.

In one embodiment, the foam that may be used in a grip in accordance with the present invention, exclusive of plasticizers or other additives such as vulcanizing agents, blowing agents, pigments, and fillers, is essentially free of copolymers derived from monomers other than nitrile monomers and diene monomers. As used herein, essentially free of copolymers derived from monomers other than nitrile monomers and diene monomers means that a ratio of the total weight of nitrile and diene repeat units of the one or more copolymers of the foam, to the total weight of non-nitrile and non-diene repeat units of the foam, is at least about 15 and more preferably at least about 25, for example, at least about 50. In one embodiment, the foam, exclusive of plasticizers or other additives such as vulcanizing agents, blowing agents, pigments, and fillers, is completely free of copolymers derived from monomers other than nitrile monomers and diene monomers. In one embodiment, the foam, exclusive of plasticizers or other additives such as vulcanizing agents, blowing agents, pigments, and fillers, consists of an acrylonitrile-butadiene-rubber.

The weight of nitrile repeat units, relative to the total weight of the nitrile and diene repat units is at least about 20 percent in exemplary copolymers. Relative to the total weight of the nitrile and diene repeat units, exemplary copolymers have less than about 70 percent of nitrile repeat units. Relative to the total weight of the nitrile and diene repeat units, exemplary copolymers have at least about 30 percent of the at least one diene repeat units. Relative to the total weight of the nitrile and diene repeat units, exemplary copolymers have less than about 80 percent of the at least one diene repeat units.

A foam of the present invention may be at least essentially free of chlorine, and preferably at least essentially free of halogens. As used herein, essentially free of halogens means that a ratio of the total weight of the nitrile and diene repeat units, to the total weight of halogen that may be present in the foam, is at least about 30, more preferably at least about 40, such as at least about 50. The foam may have less than about 3% such as less than about 1% by weight chlorine relative to the total weight of the foam. In one embodiment, the foam is completely free of chlorine and, preferably, other halogens as well.

A foam of the present invention may be at least essentially free of halogenated monomers or copolymers including halogen. Vinyl halides, for example vinyl chloride, are examples of halogenated monomers and polyvinyl chloride is an example of a copolymer formed by polymerization of a vinyl halide. Thus, a foam of the invention may be at least essentially free of copolymers formed by polymerization of one or more vinyl halides. As used herein essentially free of vinyl halide means that a ratio of the total weight of the nitrile and diene repeat units to the weight of any vinyl halide repeat units present in the foam is at least about 15, more preferably at least about 25, for example, at least about 50. In one embodiment, the foam is completely free of halogenated monomers or copolymers having halogenated repeat units.

A foam of the present invention may be at least essentially free of polyurethanes, which are understood to be formed by the reaction of the hydroxyl groups of a polyol with a curing agent, such as isocyanate. As used herein essentially free of polyurethanes means that a ratio of the total weights of the nitrile and diene repeat units, to the weight of urethane repeat units is at least about 15, such as at least about 25, for example at least about 50. In one embodiment, the foam is completely free of polyurethanes.

A foam of the present invention may be at least essentially free of aromatic monomers or aromatic repeat units derived from aromatic monomers, such as styrene. For example, a preferred foam is at least essentially free of copolymers, such as styrene, formed by polymerization of monomeric styrene. As used herein essentially free means that a ratio of the total weight of the nitrile and diene repeat units to the weight of aromatic repeat units is at least about 15 and more preferably at least about 25, for example, at least about 50. In one embodiment, the foam is completely free of styrene and of copolymers derived from polymerization of monomeric styrene, including block copolymers that include styrene segments.

A copolymer of a foam of the present invention may be polymerized by any suitable process such as emulsion polymerization, solution polymerization, suspension polymerization, bulk polymerization, or combination thereof Emulsion polymerization, which facilitates removal of the heat of polymerization, easy post-polymerization treatment, and simplification of the incidental equipment for the recovery and regeneration of an organic solvent, is preferred. In the case of emulsion polymerization, the polymer product may be obtained as a latex and solidified by a conventionally known method such as coagulation, followed by separation, washing with water and drying, whereby the resulting copolymer can be obtained. Exemplary foamable copolymers from which foams of the invention may be formed include acrylonitrile-butadiene-rubber and other rubbery polymers, e.g., copolymers.

As may be appreciated, the foam of grip elements in accordance with the present invention may include other materials in addition to the copolymer. Exemplary materials include plasticizers, blowing agents, vulcanizing agents, colorants, fillers, and the like. These materials are discussed below.

One or more plasticizers may be used to plasticize the foam thereby providing a resilient and non-brittle foam that is compressible and deformable in response to the application of gripping pressure thereto. For example, one or more plasticizers may be combined with a nitrile-diene copolymer to form a mixture, which may be foamed. In preferred foams, the total weight of plasticizer is at least about 20 percent relative to the total weight of the nitrile and diene repeat units of the copolymer. In preferred foams, the total weight of plasticizer is less than about 70 percent relative to the total weight of the nitrile and diene repeat units of the copolymer. Preferred plasticizers comprise aliphatic esters of one or more acids.

A preferred foam of the invention is plasticized by at least one adipate plasticizer, which may comprise at least one ester of an adipic acid. Di-(2-ethylhexyl) adipate is an exemplary adipate plasticizer. Other suitable adipates that may be used to plasticize foams of the invention include dibutyl adipate, diisobutyl adipate, diisononyl adipate, diisooctyl adipate, dinonyl adipate, linear adipates, and the like. As used herein, the term “adipate plasticizer” includes substituted esters of adipic acid.

In accordance with the present invention, certain plasticizers may be excluded from the foam. For example, a preferred foam of the invention is plasticized by at least one adipate plasticizer and is essentially free of non-adipate plasticizers. Non-adipate plasticizers are plasticizers that do not include an ester of an adipic acid. As used herein, essentially free of non-adipate plasticizers means that the total amount adipate plasticizers exceeds the amount of any non-adipate plasticizers present in the foam and the amount of the non-adipate plasticizers is insufficient, absent the adipate plasticizers present in the foam, to plasticize the foam and thereby provide a resilient and/or non-brittle foam that is compressible and deformable in response to application of gripping pressure thereto.

Foams that are at least essentially free of non-adipate plasticizers may be characterized by an adipate to non-adipate plasticizer ratio defined as the total weight of adipate plasticizers divided by the total weight of non-adipate plasticizers. For foams of this embodiment, this ratio is at least about 10, such as at least about 20, and more preferably, at least about 50. For example, a foam comprising 35 parts per hundred di-(2-ethylhexyl) adipate and a total of 3.5 parts per hundred non-adipate plasticizers has an adipate to non-adipate plasticizer ratio of 10. The foams of this embodiment preferably have less than about 5% by weight, such as less than about 2% by weight of non-adipate plasticizers. In one embodiment, the foam is completely free of non-adipate plasticizers.

One foam of the present invention is essentially free of phthalate plasticizers, which are esters derived from phthalic acid. Phthalate plasticizers include dioctyl phthalate, dimethyl phthalate, dihexyl phthalate, and the like. The foam is preferably plasticized by at least one adipate plasticizer. As used herein, essentially free phthalate plasticizers means that the total amount of non-phthalate plasticizers exceeds the amount of phthalate plasticizers in the foam and the amount of phthalate plasticizers is insufficient, absent non-phthalate plasticizers present in the foam, to plasticize the foam and thereby provide a resilient and/or non-brittle foam that is compressible and deformable in response to application of gripping pressure thereto.

Foams of the present invention that are plasticized by a non-phthalate plasticizer (for example, an adipate plasticizer) and that are at least essentially free of phthalate plasticizers may be characterized by a non-phthalate to phthalate plasticizer ratio defined as the total amount of non-phthalate plasticizers divided by the total amount of phthalate plasticizers. For foams of this embodiment, this ratio is at least about 10, such as at least about 20, and more preferably, at least about 50. For example, a foam comprising 35 parts per hundred di-(2-ethylhexyl) adipate and 3.5 parts per hundred dioctyl phthalate has a non-phthalate to phthalate plasticizer ratio of 10. The foams preferably have less than about 5% by weight, such as less than about 2% by weight of phthalate plasticizers. In one embodiment, the foam is completely free of phthalate plasticizers.

Another foam of the present invention is essentially free of sebacate plasticizers, which are plasticizers containing esters derived from a sebacious acid. Sebacate plasticizers include dibutyl sebacate, octyl sebacate, and the like. The foam is preferably plasticized by at least one adipate plasticizer. As used herein, essentially free of sebacate plasticizers means that the total amount of non-sebacate plasticizers exceeds the amount of sebacate plasticizers present in the foam and the amount of sebacate plasticizers is insufficient, absent non-sebacate plasticizers present in the foam, to plasticize the foam and thereby provide a resilient and/or non-brittle foam that is compressible and deformable in response to application of gripping pressure thereto.

Foams that are plasticized by at least one non-sebacate plasticizer (for example, an adipate plasticizer) and that are at least essentially free of sebacate plasticizers may be characterized by a non-sebacate plasticizer to sebacate plasticizer ratio defined as the ratio of the total amount of non-sebacate plasticizers to the total amount of sebacate plasticizers. For foams of this embodiment, this ratio is at least about 10, such as at least about 20, and more preferably, at least about 50. For example, a foam comprising 35 parts per hundred di-(2-ethylhexyl) adipate and 3.5 parts per hundred dibutyl sebacate has a non-sebacate sebacate plasticizer ratio of 10. The foams preferably have less than about 5% by weight, such as less than about 2% by weight of sebacate plasticizers. In one embodiment, the foam is completely free of sebacate plasticizers.

Another foam of the invention is essentially free of epoxy plasticizers, which are plasticizers comprising epoxy groups. Epoxy plasticizers include butyl epoxy stearate, alkyl epoxy stearate, epoxidized butyl ester, and the like. The foam is preferably plasticized by at least one adipate plasticizer. As used herein, essentially free of epoxy plasticizers means that the total amount of non-epoxy plasticizers exceeds the amount of epoxy plasticizers and the amount of epoxy plasticizers present in the foam is insufficient, absent non-epoxy plasticizers to plasticize the foam and thereby provide a resilient and/or non-brittle foam that is compressible and deformable in response to application of gripping pressure thereto.

Foams that are plasticized by at least one non-epoxy plasticizer (for example, an adipate plasticizer) and that are at least essentially free of epoxy plasticizers may be characterized by a non-epoxy to epoxy plasticizer ratio defined as the ratio of the total amount of non-epoxy plasticizers to the total amount of epoxy plasticizers. For foams of this embodiment, this ratio is at least about 10, such as at least about 20, and more preferably, at least about 50. For example, a foam comprising 35 parts per hundred di-(2-ethylhexyl) adipate and 3.5 parts per hundred butyl epoxy stearate has an adipate to epoxy plasticizer ratio of 10. In one embodiment, the foam is completely free of epoxy plasticizers.

It should be understood that foams of the present invention may be plasticized by a combination of plasticizers. For example, a foam that is at least essentially free of phthalate plasticizers may be plasticized by a combination of sebacate and adipate plasticizers. Of course, other plasticizer combinations may also be used to plasticize foams of grip elements of the invention.

As discussed above, foams include cells that preferably contain a gas upon formation of the foam. The term “foaming” may be used to describe a process that involves the formation of a foam. Gas may be mechanically introduced to a copolymer of the invention, such as by injecting a gas under pressure, agitation of the copolymer, or combination thereof. Alternatively, or in combination with mechanical introduction of gas, blowing agents may be used. A blowing agent is a compound that evolves a gas, such as upon heating the blowing agent or upon a chemical reaction between the blowing agent and another compound. Preferred blowing agents evolve nitrogen. Exemplary nitrogen-evolving, chemical blowing agents include amine compounds, such as dinitroso pentamethylene tetramine, and azide compounds, such as p,p′ oxybis (benzene sulfonyl hydrazide), benzene sulfonyl hydrazine, p-toluene sulfonyl semicarbazide, and, preferably, azodicarbonamide. The weight of the blowing agent is preferably at least about 1 percent of the total weight of the mixture to be foamed. The weight of blowing agent is preferably less than about 25 percent of the total weight of the mixture to be foamed.

Copolymers of foams of the present invention may be vulcanized. Vulcanizing agents used to vulcanize the copolymer may include elemental sulfur and compounds comprising sulfur. In one embodiment, however, the copolymer of the present invention is vulcanized with at least one non-sulfur vulcanizing agent and, therefore, is free of sulfur. Preferred non-sulfur vulcanizing agents include polynitrobenzenes, organic acid peroxides, and quinone compounds such as quinone dioximes.

It will be appreciated that foams of the invention may comprise fillers, which are preferably inert materials. Exemplary fillers include inorganic compounds, such as calcium carbonate, diatomaceous earth, carbon black, silicates, clay, and titanium dioxide. Fibrous fillers may be used. The filler may modify mechanical properties of the foam, including rigidity, density, and other visco-elastic properties. The foam may comprise as much as about 50 percent filler by weight.

Colorants may be added to modify the color or hue of the grip element. Colorants include pigments that are commonly used to impart color to rubbery copolymers. It should be understood that certain compounds, such as titanium dioxide, may alter the color or hue of a material while serving simultaneously as a filler as well.

Compounding of the copolymer blend of the present invention, as well as the compounding of the entire foamable system in which it is used, may proceed in any conventional manner. For example, a combination of the copolymer, filler, plasticizer, colorant, and any other conventional ingredients may be blended on a mill or a Banbury mixer in accordance with conventional procedures. A vulcanizing agent and blowing agent, if present, may be added when the initial combination is suitably mixed.

Foams of polymers, e.g., copolymers of the present invention may be formed or shaped as desired. For example, grip element 10 may be formed using a standard extruder. Sheets may be formed by extruding, calendering, or molding. Specially shaped objects may be formed by molding or other processes. Thus, foam of the invention may formed in any shape or geometry with any desired form or dimensions, such as length to diameter ratio etc. For example, the foam can be formed in a complex shape (e.g., with involutions and convolutions), and can be formed in any manner, such as extruded and ground, or injection molded. Thus, foams of the invention are not limited to forms suitable for use as grip elements.

Once the finished copolymer has been shaped into a desired form, it may be foamed, such as by heating the copolymer to a temperature sufficient to decompose any blowing agent present and to cure the system. As is known, foamed systems generally expand linearly in that the finished, foamed dimensions consistently bear a constant relationship to the unfoamed composition. Temperatures for expansion and cure typically range from about 100° C. to about 200° C. depending to a large extent on the thickness of the unfoamed composition to be expanded and the types and amounts of any vulcanizing agents and accellerants used.

One embodiment of the invention relates to a method for manufacturing a writing instrument having a grip element that is resilient and deformable in response to application of gripping pressure thereto. A grip element in accordance with the present invention, such as one comprising a foam comprising a copolymer having repeat units derived from a nitrile-containing monomer and a diene monomer, is operatively associated with a writing instrument. The operable association may include securing together the grip element and writing instrument, such as with adhesive or any other suitable means. The operable association may include forming the grip element in association with the writing instrument.

The presently disclosed embodiment is to be considered in all respects as illustrative and not restrictive, the scope of the invention being indicated by the appended claims, and not limited to the foregoing description.

What is claimed is:

1. A grip element configured for assembly over at least a portion of a finger-manipulable article to cushion at least the fingers of a user, said grip element comprising:
a foam comprising a copolymer having repeat units derived from a nitrile monomer and a diene monomer; and
a plasticizer to plasticize said foam; wherein said foam is essentially free of phthalate plasticizers and is resilient and deformable in response to application of gripping pressure thereto.

2. The grip element of claim 1, wherein said plasticizer comprises at least one aliphatic ester.

3. The grip element of claim 2, wherein said plasticizer comprises an adipate plasticizer.

4. The grip element of claim 3, wherein said plasticizer is di-(2-ethylhexyl) adipate.

5. The grip element of claim 1, wherein said foam is essentially free of octyl sebacate.

6. The grip element of claim 5, wherein said foam is essentially free of sebacate plasticizers.

7. The grip element of claim 1, wherein said foam is essentially free of styrene.

8. The grip element of claim 7, wherein said foam is essentially free of aromatic repeat units.

9. The grip element of claim 1, wherein said foam is essentially free of vulcanizing compounds comprising sulfur.

10. The grip element of claim 1, wherein said foam is essentially free of vinyl chloride.

11. The grip element of claim 10, wherein said foam is essentially free of halogenated repeat units.

12. The grip element of claim 1, wherein said nitrile monomer comprises at least one of acrylonitrile and methacrylonitrile.

13. The grip element of claim 1, wherein said diene is butadiene.

14. The grip element of claim 1, wherein: said nitrile monomer is acrylonitrile, said diene is butadiene, and said copolymer is acrylonitrile butadiene rubber.

15. The grip element of claim 1, wherein said foam is essentially free of poly-urethane.

16. The grip of claim 1, wherein said foam is essentially free of vinyl acetate.

17. A grip element of claim 1, wherein said grip element is configured to extend only over a gripping section of an article.

18. The grip element of claim 17, wherein the article is selected from the group consisting of writing instruments, razors, and toothbrushes.

19. The grip element of claim 18, wherein the grip element has a maximum radial dimension of less than about 2.5 centimeters.

20. A finger-manipulable article having a grip element configured to cushion at least the fingers of a user, said grip element comprising:
a foam comprising a copolymer having repeat units derived from a nitrile-containing monomer and a diene monomer; and
a plasticizer to plasticize said foam;
wherein said foam is essentially free of phthalate plasticizers and is resilient and deformable in response to application of finger gripping pressure thereto.

21 A grip element configured for assembly over at least a portion of a finger-manipulable article to cushion at least the fingers of a user, said grip element comprising:
a foam comprising a copolymer having at least nitrile repeat units and diene repeat units; and
a plasticizer to plasticize said foam,
wherein said foam is essentially free of phthalate plasticizers and is resilient and deformable in response to application of finger gripping pressure thereto.

22. A grip element configured for assembly over at least a portion of a finger-manipulable article to cushion at least the fingers of a user, said grip element comprising:
a foam configured to cushion at least the fingers of a user, said foam being compressible and deformable in response to application of finger gripping pressure thereto, wherein said foam is formed by polymerization of a mixture comprising (1) a nitrile monomer, (2) a diene monomer, and (3) a plasticizer, wherein said mixture is essentially free of aromatic esters.

23. A method for manufacturing a writing instrument, comprising:
providing a grip element comprising a foam comprising a copolymer having repeat units derived from a nitrile-containing monomer and a diene monomer; and a plasticizer to plasticize said foam;
wherein said foam is essentially free of phthalate plasticizers and is resilient and deformable in response to application of finger gripping pressure thereto;
providing a writing instrument; and
operably associating said grip element and said writing instrument.

24. The method of claim 24, wherein the operably associating step comprises permanently associating said grip element and said writing instrument.

25. A foam, the foam comprising a copolymer having repeat units derived from a nitrile monomer and a diene monomer and a plasticizer to plasticize said foam;
wherein said foam is essentially free of phthalate plasticizers and is resilient and deformable in response to application of gripping pressure thereto.
